(19) United States
(12) Patent Application Publication
(10) Pub. No.: US 2015/0221017 A1
(43) Pub. Date: Aug. 6, 2015

(54) System and Method for Displaying Recipes and Integrating Recipe Ingredients Into a Shopping List

(71) Applicants: Carmelita Oguro, San Francisco, CA (US); Collin Oguro, San Francisco, CA (US)

(72) Inventors: Carmelita Oguro, San Francisco, CA (US); Collin Oguro, San Francisco, CA (US)

(21) Appl. No.: 14/171,788

(22) Filed: Feb. 4, 2014

(51) Int. Cl. G06Q 30/06; G06F 17/30

(52) U.S. Cl. CPC G06Q 30/0633; G06F 17/30528; G06F 17/30554

(57) ABSTRACT

Techniques for displaying recipes and integrating recipe ingredients into a shopping list are provided. Ingredients, cookware, and preparation steps needed for a recipe are associated with a recipe in a database. One aspect of the invention is directed toward a database that relates ingredients, cookware, and preparation steps to recipes. Further aspects of the invention can include displaying a selected recipe in a user-friendly manner and utilizing the database to generate a display of items as a shopping list.

### CROSS-REFERENCE TO RELATED APPLICATIONS

This application claims the benefit of U.S. Provisional Application No. 61/760,893, filed Feb. 5, 2013.

### FIELD OF THE INVENTION

The present inventive concept is directed to a process of capturing recipes, planning and preparing meals, shopping for ingredients and supplies, and in particular to a system and method for displaying food preparation recipes and integrating food preparation recipe ingredients into a shopping list.

### BACKGROUND

Managing recipes can be difficult, time consuming, and a barrier to individuals who want to cook. For example, even if a user has a set of recipes they would like to use, storing and managing the recipes can be difficult. But even more difficult can be understanding exactly what steps in what order involving what ingredients need to be followed in order to effectively carry out the recipe. It can also be difficult to ensure one has all the ingredients needed.

Preparing meals can be a frustrating task when the preparer discovers that one or more needed ingredients or needed cookware are not on hand. Once preparation has begun, it is usually too late to run to the store to get the missing ingredients or cookware. Even when ingredients are shopped for ahead of time, some ingredients may be forgotten or ingredients already on hand may be mistakenly purchased.

Further, coordinating a large number of ingredients while performing steps specified in a recipe can be confusing, leading to necessary ingredients being left out of the recipe or being improperly combined with other ingredients. In addition, recipes may be stored in a disorganized manner and may therefore be difficult to locate, making successful meal planning and preparation a challenge.

### SUMMARY

A system and method for displaying recipes and integrating recipe ingredients into a shopping list are provided.

The systems and methods for displaying recipes and integrating recipe ingredients into a shopping list described herein provide a holistic approach that allows a user to store, access, and organize their recipes quickly and easily. Then when the user pulls up the recipe, they do not just get a list of ingredients, but rather the list of ingredients is presented along with a description of the steps involved in preparing the recipe. The list of ingredients can then be associated with the corresponding steps, e.g., through numbering, color coding, some combination thereof, or some other means of coding. This way, when the user views the recipe, the user immediately sees what ingredients are going to be needed for each step as well as what steps need to be performed in what order.

Additionally, the recipe can be linked to a shopping list functionality, such that the user can quickly select all or select a subset of the ingredients to be added to the user's shopping list.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a block diagram of a shopping list generating system, according to an embodiment of the present invention;

FIG. 2 is a flow diagram illustrating a methodology for integrating a recipe into a shopping list, according to an embodiment of the present invention;

FIG. 3 is a flow diagram illustrating a methodology for sorting a shopping list on a mobile device, according to an embodiment of the present invention;

FIG. 4 is a schematic diagram of function modules of one system for displaying a shopping list integrated with a recipe, according to an embodiment of the present invention;

FIG. 5 is a screen view of a user-friendly recipe, according to an embodiment of the present invention;

FIG. 6 is a screen view of a shopping list on a mobile device, according to an embodiment of the present invention;

FIG. 7 is a screen view of a cookbook generator, according to an embodiment of the present invention;

FIG. 8 is a screen view of a cookbook, according to an embodiment of the present invention;

FIG. 9 is a screen view of a cookbook table of contents, according to an embodiment of the present invention.

### DETAILED DESCRIPTION

This disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

The present inventive concept may be implemented on a mobile device or desktop computer using software and/or hardware units or modules. In addition, an application embodying the present inventive concept may be locally installed or web-based.

The terms “unit” and “module” may refer to software and hardware constituent elements, such as a Field Programmable Gate Array (FPGA) or an Application Specific Integrated Circuit (ASIC). The units and modules perform functions. However, this does not mean that a module is limited to software or hardware. Modules may be configured to exist in a storage medium which is addressable and may be configured to execute on one or more processing units. For example, a module may include constituent elements, such as software constituent elements, object-oriented software constituent elements, class constituent elements and task constituent elements, processes, functions, attributes, procedures, subroutines, segments of program code, drivers, firmware, microcodes, circuits, data, databases, data structures, tables, arrays, and parameters. Functions provided within the constituent elements and the modules may be combined with a smaller number of constituent elements and modules or may be separated into additional constituent elements and modules. Furthermore, the constituent elements and the modules may be implemented to execute on one or more CPUs within a device.

Computer program instructions can be loaded into the processing unit of a general-purpose computer, a special purpose computer, and other programmable data processing equipment. Therefore, the instructions executed by the processing units of the computers or other programmable data processing equipment create means for performing functions of displaying food preparation recipes and integrating food preparation recipe ingredients into a shopping list. The computer program instructions can be stored in a computer-available or computer readable memory that can be provided to the computer or other programmable data processing equipment in order to implement the functions in a specific manner. Since the computer program instructions can be mounted on the computer or other programmable data processing equipment, a series of operating steps is performed on the computer or other programmable data processing equipment to create a process executed by the computer.

The present invention provides a system and method of integrating food preparation recipes into shopping lists. In the following description, numerous specific details are set forth by way of exemplary embodiments in order to provide a more through description of the present invention. It will be apparent, however, to one skilled in the art, that the present invention may be practiced without these specific details. In other instances, well-known features have not been described in detail so as to not obscure the invention. The preferred embodiments of the inventions are described herein in the Detailed Description, Figures, and Claims. Unless specifically noted, it is intended that the words and phrases in the specification and claims be given the ordinary and accustomed meaning as understood by those of skill in the applicable art. If any other meaning is intended, the specification will specifically state that a special meaning is being applied to a word or phrase.

One aspect of the present inventive concept provides for centralized digital storage of recipes in various formats, for example, but not limited to, scanned clippings from magazines and books, PDFs, bookmarked pages, screenshots, photos, recipes available from a subscription service, etc. Thus, recipes may be maintained in a centralized location. Ingredients and preparation steps for the recipes may be entered into a database as further explained below.

The database may be searched and/or filtered for recipes based on various criteria, for example, but not limited to, vegetarian meals, ethnic meals, flavor profile, etc. Further, recipes may be filtered based on a combination of ingredients to determine which recipes may be prepared with those ingredients.

A user's flavor profile may be provided or calculated to determine user taste preferences. The flavor profile may then be used to search for recipes in the database which a user may like. The flavor profile may also be used to programmatically filter out recipes that users cannot or prefer not to eat, which in turn would give the user an enriched, customized content experience.

Recipes may be shared via email and/or social media applications. Users may also define their social network within the application and have the ability to grant permission to see recipes. Recipes may be published and can also be subject to various states with varying visibility within the system.

The present inventive concept provides a database that relates ingredients, cookware, and preparation steps to recipes. Further, other attributes may be related to the ingredients and recipes in the database. For example, a store where a user prefers to purchase an ingredient and/or a section in the store where the ingredient can be found may be related to the ingredient in the database. Links to websites which are sources for purchasing cookware may be provided. Such links will be instrumented to credit the inventive concept for driving sales on the cookware website.

In addition, an ingredient purchase history, which may be used as a reminder to check whether an ingredient is on hand, may be created and related to the ingredient. One of ordinary skill in the art will appreciate that the foregoing are merely examples and that other attributes may be related to the ingredients in the database without departing from the inventive concept.

Through a user interface, recipe ingredients can be entered simply as ingredients alone, or they may be entered with additional details, for example, but not limited to, units of measure, quantity, and preparation notes. The present inventive concept parses the different pieces of information (data), for example, ingredients, units of measure, quantity, and preparation notes units of measure for inclusion in the appropriate database tables, thereby enabling data entry with minimal effort. Cookware necessary to prepare the recipe may be similarly entered. Batch editing of the data provided through the user interface allows updating of multiple items.

Recipe preparation steps may be entered through the user interface. Each preparation step can be preceded by a number indicating its position in the preparation sequence. The present inventive concept parses each preparation step preceded by a number into the database tables as a separate step.

Another aspect of the present inventive concept displays a selected recipe in a user-friendly manner. Recipes may be displayed using a combination of visual cues including color codes, numbers, and colored highlights to identify various aspects of the recipe preparation steps and ingredients. For example, preparation steps may be displayed in a numerical sequence as entered, and each step in the sequence may be associated with a color code. Ingredients required for a particular preparation step may be identified with the same color code. To facilitate quick identification, the ingredient is listed first, followed by quantity and the measurement units.

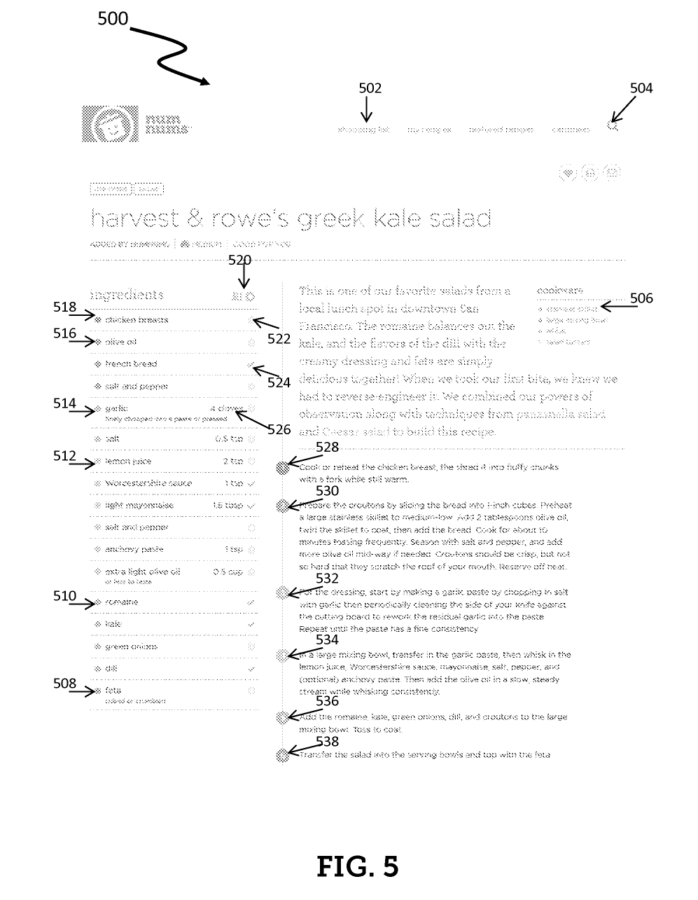

FIG. 5 shows a screen view of a user-friendly recipe 500 according to a particular embodiment of the invention. Cookware needed for the recipe 506 are shown near the introduction to the recipe. The preparation steps are shown in color coded sequence below the introduction. Preparation step 1 528 has the same color code as the ingredients needed for preparation step 1 518. Preparation step 2 530 has the same color code as the ingredients needed for preparation step 2 516. Preparation step 3 532 has the same color code as the ingredients needed for preparation step 3 514. Preparation step 4 534 has the same color code as the ingredients needed for preparation step 4 512. Preparation step 5 536 has the same color code as the ingredients needed for preparation step 5 510. Preparation step 6 538 has the same color code as the ingredients needed for preparation step 6 508. Ingredients are listed by quantity and the measurement unit 526. Ingredients can be added to the shopping list individually 522 or all of the ingredients needed for recipe the can be added at once 520. Ingredients that have already been added to the shopping list are identified with a check mark 524. Links to an existing shopping list 502 and the search function 504 can be found in the header of the recipe.

The present inventive concept calculates ingredient quantities to permit recipes to be scaled up or down. In addition, temperature settings and cooking times within the preparation steps may be identified with consistently colored highlights which identify them within the preparation steps as temperature settings and cooking times.

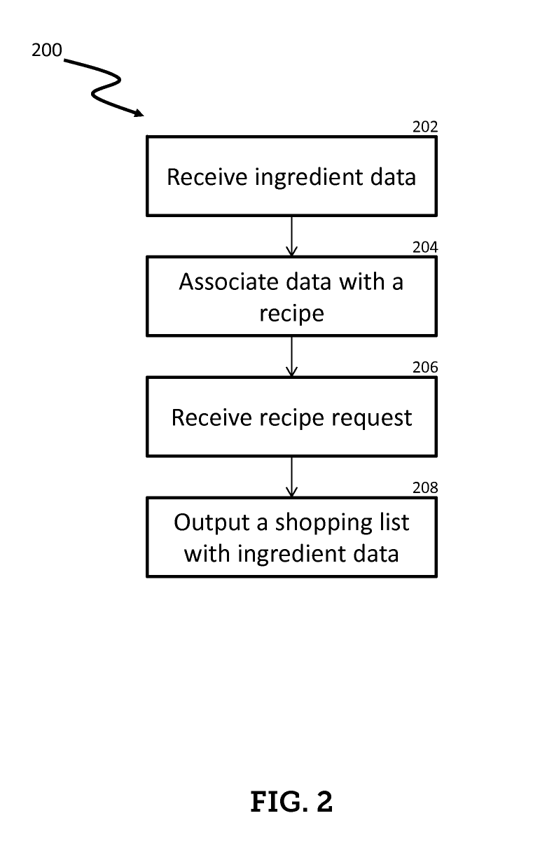

Another aspect of the present inventive concept utilizes the database to generate a display of items as a shopping list. FIG. 2 illustrates a method of outputting a shopping list with a data of an ingredient 200, according to a particular embodiment of the invention. The database receives a data of an ingredient 202 for a recipe entered in using a user interface. Then the data of the ingredient is associated with a recipe 204. After receiving a request for a recipe 206, a shopping list comprising some data of the ingredient is outputted 208.

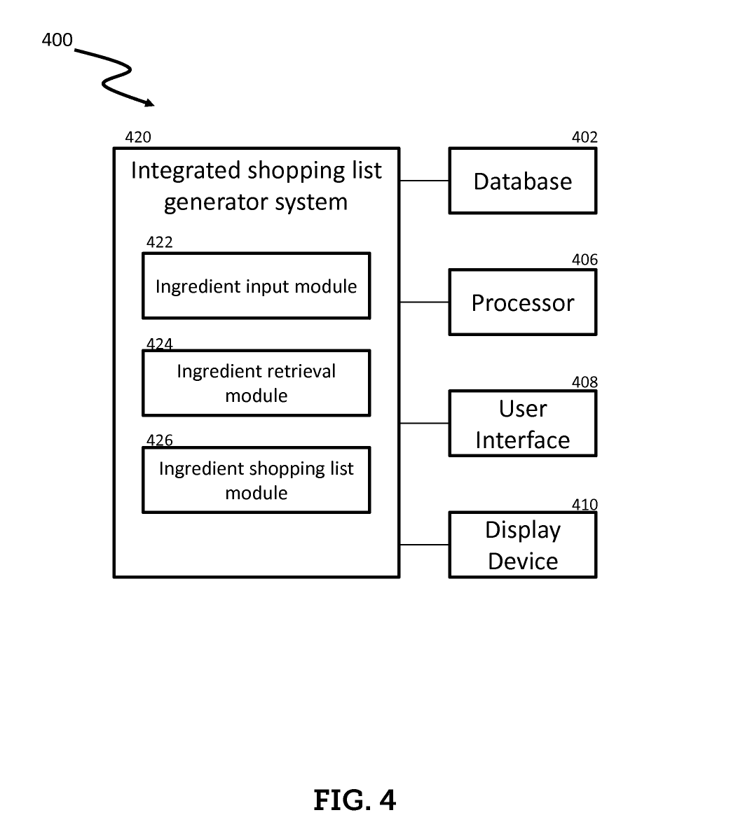

FIG. 4 is a schematic diagram of function modules of one system for displaying a shopping list integrated with a recipe 400, according to a particular embodiment of the invention. In the embodiment, the integrated shopping list generator system 420 includes an ingredient input module 422, an ingredient retrieval module 424, and an ingredient shopping list module 426. Each of the modules may be a software program including one or more computerized instructions that are executed by the processor 406. A database 402 can be configured to store the recipe and a data of an ingredient of the recipe. A data of an ingredient to be associated with a recipe may be entered into the database via the ingredient input module 422 using a user interface 408. An ingredient retrieval module 424 can be configured to retrieve at least a portion of the data of the ingredient associated with the recipe. An ingredient shopping list module 426 can be configured to output a recipe comprising at least a portion of the data of the ingredient associated with the recipe.

In certain embodiments, ingredients and cookware related to a selected recipe may be added to the shopping list by a single click from the recipe display. Similarly, all ingredients for a recipe may be deleted from the shopping list by a single click from the shopping list display. Items that are not automatically entered on the shopping list as part of a recipe may be manually added to the shopping list through a user interface.

Items on the shopping list which may already be on hand based on purchase history of the item in the database, and/or items which a user thinks may be on hand, may be indicated as such on the shopping list to remind the user to check if the items are on hand before shopping for them. The indication may be in the form of, for example, but not limited to, a graphic indication or other flag displayed in proximity to the item on the shopping list display.

Items may be crossed off of the shopping list after purchase by swiping across the display in either direction or by a specified action of a mouse or other human interface device. A list of completed items which were crossed off the shopping list after purchase may be displayed. For maintaining a purchase history, a time starting from the date an item is crossed off a shopping list may be calculated to determine that an item needs to be repurchased. Items may also be determined as “on hand” if purchased prior to the repurchase time and those items automatically flagged or removed from the shopping list.

Items on the shopping list may be sorted by several categories. For example, items may be sorted by recipe or alphabetically by item. Items may be sorted according to a preferred store for purchasing the item if the user previously entered that data into the database. Items may be categorized according to a section of a store where they may be found, for example, produce section or freezer section if the user previously entered that data into the database. Some items may have predetermined categories, for example, milk in the refrigerator section and bread in the bakery section.

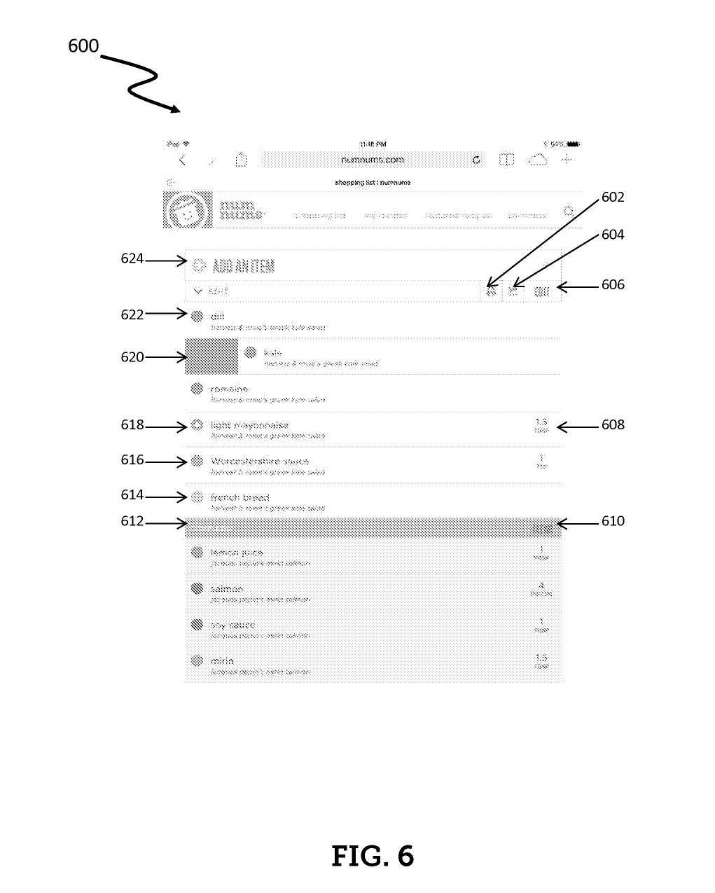

FIG. 6 shows a screen view of a shopping list on a mobile device 600 according to a particular embodiment of the invention. The shopping list can be printed 602 or emailed 604 to an email account. Items can be added to the shopping list individually 624 and the entire list can be batch edited 606. Items can be sorted by section of the store they can be found in and color coded accordingly. In the embodiment, items found in the produce section are coded with the color green 622, items found in the pantry section of the store are coded orange 616, and items found in the deli & bakery section of the store are coded with the color yellow 614. Items that may already be on hand are flagged 618. Items are listed by quantity and measurement unit 608 and are crossed off the shopping list by swiping 620 across the display. After an item is crossed off it is shown in the completed section 612 which can be cleared 610.

Items may be color coded based on the section of the store in which they can be found, and sorted according to the color code. One of ordinary skill in the art will appreciate that the foregoing are merely examples and that other sorting schemes may be used without departing from the inventive concept. In addition, a shared shopping list which may be remotely modified by multiple users may be created.

In certain embodiments, the application can actually recognize when certain items are already included in the user's shopping list and indicate such to the user, or simply prevent the addition from creating duplicate entries. In certain embodiments, the application can actually automatically assess which ingredients are likely going to need to be purchased, based on what items the user has purchased in previous trips to the store, when the last time the user bought certain items, the frequency with which these items need to be purchased, etc.

In other words, the application can predict, based on the user's purchases and the how long certain items usually last, based either on the what the item is or the frequency with which the user normally purchases the item, e.g., every week, every month, once a year, etc., what items in a recipe that user is likely to have on hand, and which ones they are not likely to have.

In certain embodiments, the cookware needed for each step can also be displayed with the ingredients and steps. Accordingly, the application allows a user to easily manage not just the shopping, but also the preparation and cooking by integrating the shopping list function with the recipe function and by coding the ingredients based on the related recipe steps.

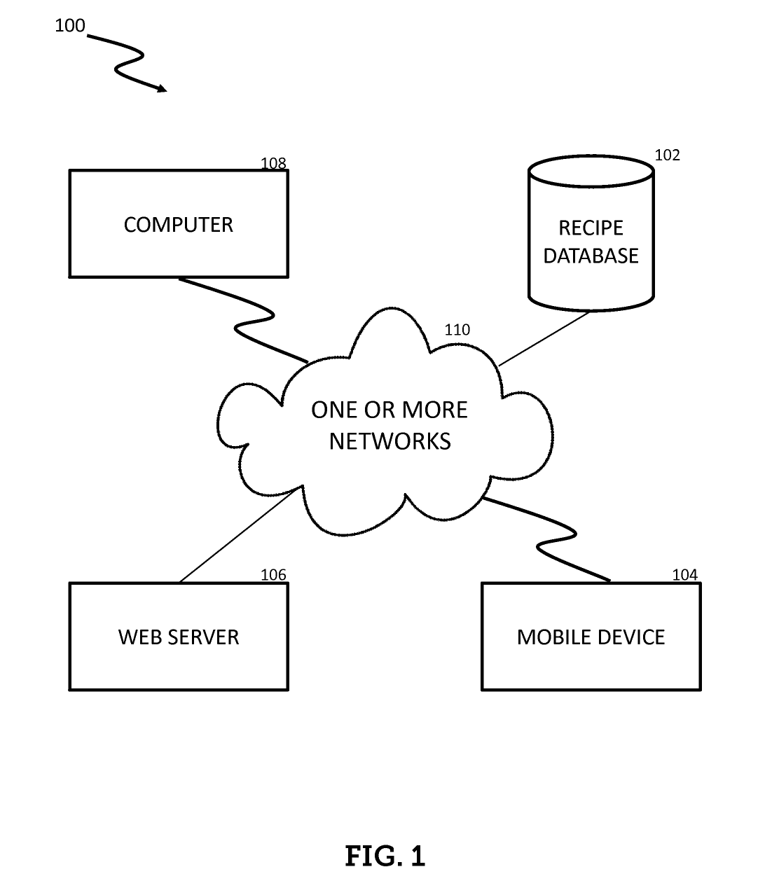

The shopping list functionality can have numerous helpful functions and can have a mobile application component to allow the user to take the list to the store with them. FIG. 1 is a block diagram of a shopping list generating system 100 according to a particular embodiment of the invention. In the embodiment, the system includes at least one computer 108 (e.g. a desktop computer, laptop, smart phone, tablet, or other suitable computer) at least one recipe database 102, at least one web server 106, and at least one mobile device 104 (e.g. a smart phone, tablet, or other suitable mobile device). One or more computer networks 110 facilitate communication between the computer 108, recipe database 102, web server 106, and mobile device 104. The one or more computer networks 110 may include any of a variety of types of computer networks such as the Internet, a private intranet, or any other type of network known in the art.

In one embodiment, the computer 108 may use one or more computer networks 110 to access the recipe database 102 and to create a shopping list that is accessible on the web server 106. When out shopping, a mobile device 104 can use one or more computer networks 110 to access the shopping list on the web server 106.

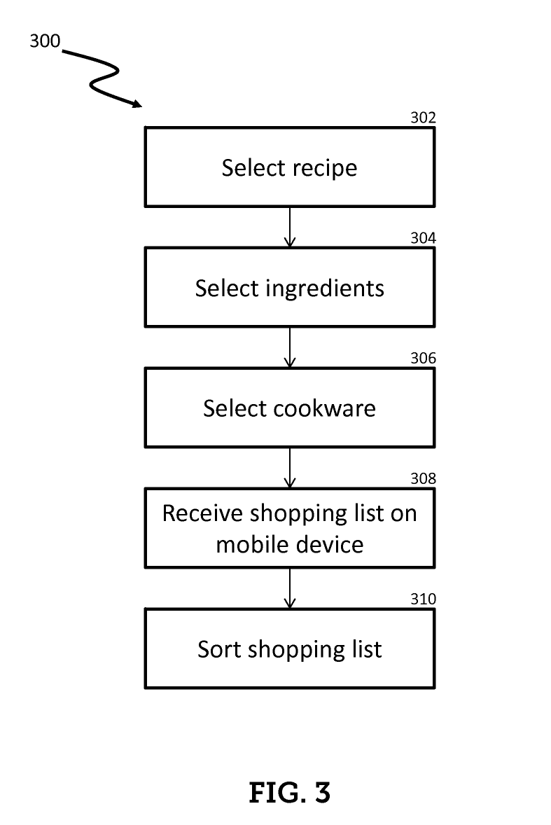

In certain embodiments, the items on the shopping list can be organized, automatically, manually, or both, by grocery store section. FIG. 3 illustrates a method of obtaining and sorting a shopping list on a mobile device 300 according to a particular embodiment of the invention. A user can select a recipe 302 that they want to prepare. Then the user can select ingredients 304 and/or select cookware 306 associated with the recipe that they want added to a shopping list. When out shopping the user can receive the shopping list on a mobile device 308 and then sort the list 310 according to the section of the store the shopping list item can be found in.

Each item can also be color coded or otherwise visually coded according to section. As the user puts the items in their cart, they can then swipe the item in the list on their mobile application to remove it. Visual coding allows the user to quickly see that they are done in a certain section so they can move to the next, when all associated items have been “swiped” off the list. The swiping function will be addressed in more detail below.

The user can also associate a certain store with each item in the list. Thus, the user can quickly see what items they need to get in which store. So for example, if the user buys certain items at Costco and others at Trader Joe's, then when the user is entering or near one of these stores they can quickly assess what they need in the store and get the items as efficiently as possible. In certain embodiments, the application will remember what store was associated with a particular item so that the user only need make the association once. A similar mechanism also remembers the store section to which items are associated. In some cases, the application will trigger geo-location reminders when it detects that the user is near a store that the user frequents or when it detects that the user's shopping list contains items that can be purchased at nearby stores.

In certain embodiments, there are one-to-many relationships between a recipe and its associated ingredients. This embodiment allows for easily planning shopping trips for specific recipes and repeating a dish that has already been cooked once.

In certain embodiments, users can flag shopping list items. This embodiment allows users to flag ingredients if they have to revisit the ingredient such as if to check if the user already has the ingredient on hand. In certain embodiments users are able to add one-off items to a shopping list. This embodiment allows users to add items that may not be associated with a recipe in the database including, for example, but not limited to, drinks, toiletries, or other items that need to be purchased on a shopping trip. In certain embodiments, users can merge shopping lists. This embodiment allows, for example, including, but not limited to, merging shopping lists tied to specific recipes with each other and with shopping lists for one-off items. There are also numerous view settings that can be applied to the display of the recipes to help the user organize them.

In certain embodiments, users can upload their recipes to a web site where they can be stored and accessed by the user, the user's contacts as set up on the site, or by anyone. The user can have an account through which they browse recipes, add them to their own recipe lists, share them with contacts, make shopping lists, etc. As noted the shopping lists can be ported to a mobile application so that the user can access them in a convenient format on their mobile device.

In certain embodiments, users can have selected recipes compiled as a cookbook with a table of contents. This allows for rapid production of a cookbook that may be gifted or sold at various events such as fundraisers, weddings, and other functions.

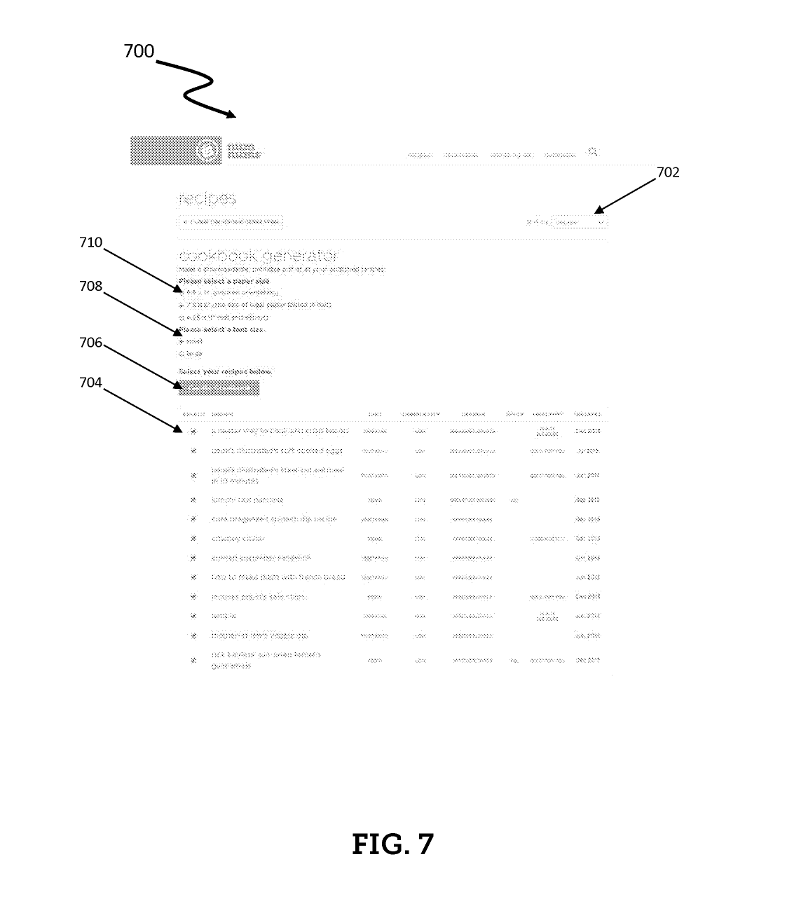

FIG. 7 shows a screen view of a cookbook generator 700, according to a particular embodiment of the invention. The user can select one or more recipes 704 based on user-selected criteria including, for example, but not limited to, favorite recipes, vegetarian meals, ethnic meals, flavor profile, and one or more ingredient. The user can sort 702 the list of selected recipes by categories including diet, complexity, course, spiciness, and healthiness. After the user selects a paper size 710 and a font size 708, a cookbook can be outputted 706 in a text file format such as, for example, but not limited to a Word format, a rich text format, and a portable document format.

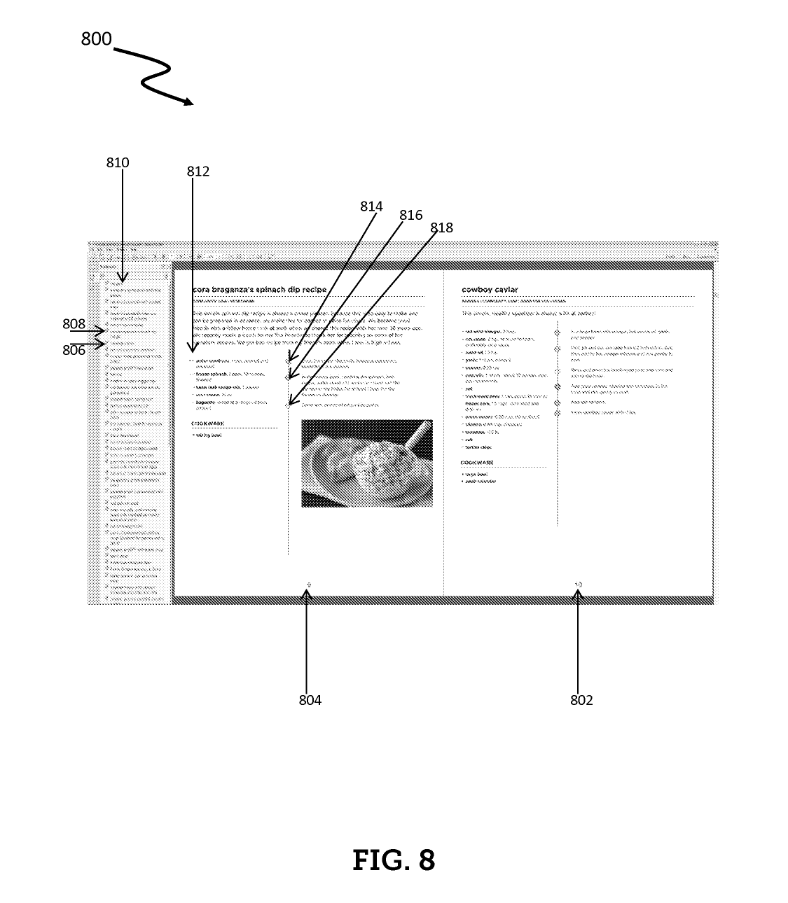

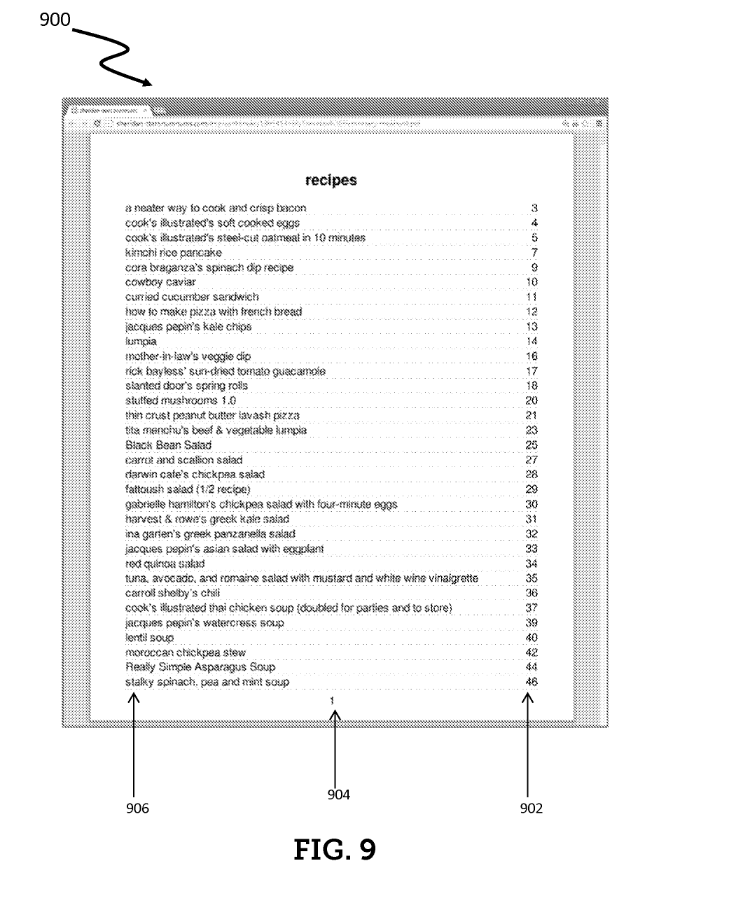

FIG. 8 shows a screen view of a cookbook with table of contents 800 generated by the cookbook generator in FIG. 7. A table of contents 810 is inserted in the cookbook and lists the recipes 806, 808 contained in the cookbook. Each recipe is given its own page number 802, 804. Ingredients 812 are shown on the left side of a user-friendly recipe with preparation step 1 814, preparation step 2 816, and preparation step 3 818 listed numerically on the right side of the recipe with their respective color code. FIG. 9 is a screen view of the table of contents 900 generated by the cookbook generator in FIG. 7. The table of contents is inserted in the cookbook on the first page 904. The recipes are listed 906 with the corresponding page number 902 they can be found on.

In certain embodiments, certain items such as ingredients or cookware can be associated with an affiliate. Thus, for example, when a user first pulls up a recipe, the ingredients can be linked to specific brands or stores that carry the ingredient. When the user selects an ingredient, the default store associated with the item, can in certain embodiments, be the affiliate store.

Moreover, as a user selects certain recipes, the site can begin to learn what the user likes. The site can suggest recipes, connections to other users or use groups that like similar recipes, pairings, e.g., wines, which may or may not be sponsored by an affiliate.

By linking location with the users, the site can actually see shopping, dietary, and other consumption patterns by neighborhood, metropolitan area, or other location defined areas. This information can be used to help stores market to consumers, know when to stock certain items, how much to stock, what brands to stock, when to put items on sale, etc. In fact, stores can use this information to push deals, discounts, coupons, etc., to users, either through the site or through their mobile devices.

The swipe function was mentioned above. In certain embodiments, the mobile application can be configured with a bi-directional swipe functionality. In other words, when a user, e.g., wants to swipe an item to add or delete it from a list, the user can swipe over that item on the screen of the mobile device in either direction. The result will be the same regardless of the direction of the swipe, e.g., the item will be removed. This bi-directional swipe functionality can be useful in a store where the user is pushing a cart, may be reaching for either side of an aisle, may be managing small children at the same time, etc. and of course holding their device. It is also useful if someone who is left handed to be able to swipe in one direction while holding the device in their left hand, while people who are right handed can make the same, but mirrored movement while holding the device in their right hand.

In other embodiments, the application can allow the user to set whether they want the application to work in a left handed or right handed mode. The settings will then enable swipes in one direction or the other. In fact the entire layout and activation mechanisms can mirror depending on such a selection.

One of ordinary skill in the art will appreciate that the present inventive concept can be applied to other process/methods involving a plurality of necessary items and instructions for combining/using such items to achieve an end result, for example, but not limited to, furniture assembly, applying cosmetics, etc., without departing from the scope of the present inventive concept.

The above description is illustrative only and is not limiting. Therefore, this description is merely illustrative, and the present invention is defined solely by the claims that follow and their full range of equivalents.

1. A method of integrating a food preparation recipe into a shopping list, comprising:
entering, with a user interface of an electronic device, data of an ingredient of the recipe into a database stored in a storage;
associating the data of the ingredient and the recipe in the database;
querying the database for the recipe; and
outputting from the database a shopping list comprising at least a portion of the data of the ingredient associated with the recipe.

2. The method of claim 1, further comprising:
sorting the shopping list by at least one category.

3. The method of claim 1, further comprising:
crossing items off the shopping list using a user interface of an electronic device.

4. The method of claim 1, further comprising:
flagging items on the shopping list using a user interface of an electronic device.

5. The method of claim 1, further comprising:
adding items to the shopping list using a user interface of an electronic device.

6. The method of claim 1, further comprising:
merging the shopping list with other existing shopping lists.

7. The method of claim 1, further comprising:
color coding items on the shopping list based on a section of a store where they may be found.

8. The method of claim 1, further comprising:
associating an ingredient purchase history with an ingredient in the database.

9. The method of claim 1, further comprising:
filtering the database for a recipe by at least one category.

10. The method of claim 1, further comprising:
outputting from the database a user-friendly recipe comprising at least a portion of the data of the ingredient associated with a recipe.

11. The method of claim 10, further comprising:
displaying the user-friendly recipe using visual cues including at least one of color codes, numbers, or colored highlights.

12. The method of claim 11, further comprising:
outputting from the database a compilation of at least one user-friendly recipe as a cookbook.

13. The method of claim 1, further comprising:
entering, with a user interface of an electronic device, at least one cookware needed for the recipe into a database stored in a storage; and
associating at least one cookware needed for the recipe and the recipe in the database.

14. The method of claim 13, further comprising:
outputting from the database a shopping list comprising at least one cookware associated with the recipe.

15. The method of claim 13, further comprising:
associating at least one cookware needed for the recipe with an affiliate store in the database.

16. The method of claim 15, further comprising:
outputting from the database a shopping list comprising links to websites which are sources for purchasing at least one cookware needed for the recipe.

17. The method of claim 13, further comprising:
outputting from the database a user-friendly recipe comprising at least one cookware associated with a recipe.

18. The method of claim 1, further comprising:
entering, with a user interface of an electronic device, at least one preparation step needed for the recipe into a database stored in a storage; and
associating at least one preparation step needed for the recipe and the recipe in the database.

19. The method of claim 18, further comprising:
outputting from the database a shopping list comprising at least one preparation step associated with the recipe.

20. The method of claim 18, further comprising:
outputting from the database a user-friendly recipe comprising at least one preparation step associated with a recipe.

21. The method of claim 1, further comprising:
associating at least one user with the user's location data.

22. The method of claim 21, further comprising:
analyzing at least one user's location data to discern consumption patterns for a given location defined area.

23. The method of claim 21, further comprising:
triggering geo-location reminders when it detects items on a shopping list can be purchased at nearby stores.

24. The method of claim 23, further comprising:
offering affiliate promotions for items on a user's shopping list.

25. The method of claim 1, further comprising:
associating a flavor profile with a user.

26. A non-transitory computer readable medium having stored therein a program executable by a processor for causing the processor to access a database integrating a food preparation recipe into a shopping list, said program including computer executable instructions for performing steps comprising:
entering data of an ingredient of the recipe into a database stored in a storage;
associating, in the database, the data of the ingredient and the recipe;
querying the database for the recipe; and
outputting from the database a shopping list comprising at least a portion of the data of the ingredient associated with the recipe.

27. The non-transitory computer readable medium of claim 26, the computer executable instructions for performing steps further comprising:
sorting the shopping list by at least one category.

28. The non-transitory computer readable medium of claim 26, the computer executable instructions for performing steps further comprising:
crossing items off the shopping list using a user interface of an electronic device.

29. The non-transitory computer readable medium of claim 26, the computer executable instructions for performing steps further comprising:
flagging items on the shopping list using a user interface of an electronic device.

30. The non-transitory computer readable medium of claim 26, the computer executable instructions for performing steps further comprising:
adding items to the shopping list using a user interface of an electronic device.

31. The non-transitory computer readable medium of claim 26, the computer executable instructions for performing steps further comprising:
merging the shopping list with other existing shopping lists.

32. The non-transitory computer readable medium of claim 26, the computer executable instructions for performing steps further comprising:
color coding items on the shopping list based on a section of a store where they may be found.

33. The non-transitory computer readable medium of claim 26, the computer executable instructions for performing steps further comprising:
associating an ingredient purchase history with an ingredient in the database.

34. The non-transitory computer readable medium of claim 26, the computer executable instructions for performing steps further comprising:
filtering the database for a recipe by at least one category.

35. The non-transitory computer readable medium of claim 26, the computer executable instructions for performing steps further comprising:
outputting from the database a user-friendly recipe comprising at least a portion of the data of the ingredient associated with a recipe.

36. The non-transitory computer readable medium of claim 35, the computer executable instructions for performing steps further comprising:
displaying the recipe using visual cues including at least one of color codes, numbers, or colored highlights.

37. The non-transitory computer readable medium of claim 36, the computer executable instructions for performing steps further comprising:
outputting from the database a compilation of at least one user-friendly recipe as a cookbook.

38. The non-transitory computer readable medium of claim 26, the computer executable instructions for performing steps further comprising:
entering, with a user interface of an electronic device, at least one cookware needed for the recipe into a database stored in a storage; and
associating at least one cookware needed for the recipe and the recipe in the database.

39. The non-transitory computer readable medium of claim 38, the computer executable instructions for performing steps further comprising:
outputting from the database a shopping list comprising at least one cookware associated with the recipe.

40. The non-transitory computer readable medium of claim 38, the computer executable instructions for performing steps further comprising:
associating at least one cookware needed for the recipe with an affiliate store in the database.

41. The non-transitory computer readable medium of claim 40, the computer executable instructions for performing steps further comprising:
outputting from the database a shopping list comprising links to websites which are sources for purchasing at least one cookware needed for the recipe.

42. The non-transitory computer readable medium of claim 38, the computer executable instructions for performing steps further comprising:
outputting from the database a user-friendly recipe comprising at least one cookware associated with the recipe.

43. The non-transitory computer readable medium of claim 26, the computer executable instructions for performing steps further comprising:
entering, with a user interface of an electronic device, at least one preparation step needed for the recipe into a database stored in a storage; and
associating at least one preparation step needed for the recipe and the recipe in the database.

44. The non-transitory computer readable medium of claim 43, the computer executable instructions for performing steps further comprising:
outputting from the database a shopping list comprising at least one preparation step associated with the recipe.

45. The non-transitory computer readable medium of claim 43, the computer executable instructions for performing steps further comprising:
outputting from the database a user-friendly recipe comprising at least one preparation step associated with the recipe.

46. The non-transitory computer readable medium of claim 26, the computer executable instructions for performing steps further comprising:
associating at least one user with the user's location data.

47. The non-transitory computer readable medium of claim 46, the computer executable instructions for performing steps further comprising:
analyzing at least one user's location data to discern consumption patterns for a given location defined area.

48. The non-transitory computer readable medium of claim 46, the computer executable instructions for performing steps further comprising:
triggering geo-location reminders when it detects items on a shopping list can be purchased at nearby stores.

49. The non-transitory computer readable medium of claim 48, the computer executable instructions for performing steps further comprising:
offering affiliate promotions for items on a user's shopping list.

50. The non-transitory computer readable medium of claim 26, the computer executable instructions for performing steps further comprising:
associating a flavor profile with a user.

51. A system for integrating a food preparation recipe into a shopping list:
an ingredient database configured to store a recipe and data of an ingredient of the recipe;
a processor to execute modules, comprising:
an ingredient input module configured to collect at least a portion of the data of an ingredient of the recipe;
an ingredient retrieval module configured to retrieve at least a portion of the data of the ingredient associated with the recipe; and
an ingredient shopping list module configured to output a recipe comprising at least a portion of the data of an ingredient associated with the recipe.

52. The system of claim 51, further comprising a user-friendly recipe module configured to output a recipe comprising at least a portion of the data of an ingredient associated with the recipe.

53. The system of claim 51, further comprising:
a cookware database configured to store a recipe and at least one cookware needed for a recipe;
a cookware retrieval module configured to retrieve at least one cookware associated with the recipe;
a recipe module configured to output a user-friendly recipe comprising at least one cookware associated with the recipe;
a cookware shopping list module configured to output a shopping list comprising at least one cookware associated with the recipe.

54. The system of claim 51, further comprising:
a preparation step database configured to store at least one preparation step needed for a recipe;
a preparation step retrieval module configured to retrieve at least one preparation step associated with the recipe;
a recipe module configured to output a user-friendly recipe comprising at least one preparation step associated with the recipe;
a preparation step shopping list module configured to output a shopping list comprising at least one cookware associated with the recipe.

55. The system of claim 52, further comprising:
a cookbook creation module configured to output a cookbook in a text format comprising at least one user-friendly recipe.

56. The system of claim 51, further comprising:
a color coding module configured to color code items on the shopping list based on the section of a store where they may be found.

57. The system of claim 51, further comprising:
a location module configured to associate at least one user with the user's location data.
